(19) United States
(12) Patent Application Publication
(10) Pub. No.: US 2004/0144861 A1
(43) Pub. Date: Jul. 29, 2004

(54) Shaped fragrance dispenser

(76) Inventor: James Hawkins, Henderson, NC (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/714,530

(22) Filed: Nov. 14, 2003

Related U.S. Application Data
(60) Provisional application No. 60/426,179, filed on Nov. 15, 2002.

(51) Int. Cl. B05B 9/03

(52) U.S. Cl. 239/302

(57) ABSTRACT

A spray-type fragrance dispenser is disclosed which includes a body of any desired shape. Preferably, the body is formed in the shape of an animal or other object to accompany the decor of the location in which the dispenser is to be placed. The dispenser includes a tube between the release valve of the fragrance and a spray head to allow positioning of the spray head anywhere on the body.

### BACKGROUND OF THE INVENTION

1. Field of the Invention

This application claims priority to provisional application U.S. Ser. No. 60/426,179, filed on Nov. 15, 2002, the entire contents of which is hereby incorporated by reference. The present invention relates to fragrance dispensers. More particularly, it relates to air freshener containers with hand activated sprays having novel shapes.

2. Discussion of Related Art

Various mechanisms are known dispersing fragrances into the atmosphere to limit or create specific odors, including burning incense, spraying perfumes and evaporating scented liquids or gels. Each of these mechanisms has various advantages and disadvantages. One of the major disadvantages of any fragrance dispensing mechanism is the appearance of the dispenser.

Some attempts have been made to improve the appearance of scented liquid or gel systems by the use of a decorative outer container. For example, U.S. Pat. No. 4,928,881 discloses an air freshener having a base holding a scented liquid, a wick extending from the base, and a decorative opaque shroud or cover surrounding the wick in the form of flower petals which hides the wick. Since such systems provide long-lasing dispensing, over days or months, and are placed in visible areas, the appearance can be important.

Fewer attempts have been made to improve the appearance of spray type dispensers. Such systems dispense materials by way of an aerosol or pump activated spray dispenser into the air as minute droplets or spray. The materials most commonly dispersed by active dispensers include materials selected from the group consisting of fragrances, air fresheners, deodorizers, insecticides, and insect repellants. Often, the dispenser is operated while sitting on a level surface such as a table top or is hand held.

Such active dispensers are frequently used for fragrances, or for air-freshening compositions. Such dispensers are not generally left in highly visible areas. Furthermore, such dispensers require an actuation mechanism and a dispensing head forreleasing the dispersing the fragrance material. The dispenser shape is defined by these functional requirements. Thus, the little has been done to improve the appearance of such dispensers. U.S. Pat. No. 5,358,147 discloses an attempt to improve the appearance of a spray type dispenser. The spray dispensing package includes an outer shell and a refill cartridge that fits therein and includes a spray valve, valve stem, and a spray nozzle. The outer shell has guide surfaces to cooperate with the refill cartridge to allow the shell to slide smoothly relative thereto when pressure is applied to the top surface of the shell to activate the spray valve on the refill cartridge. Still, in the design of the outer shell is limited by the position and operation of the activator on the refill cartridge.

### SUMMARY OF THE INVENTION

The present invention a decorative spray-type fragrance dispenser which formed in desirable shapes. According to an aspect of the invention, the fragrance dispenser includes a pressurized fragrance chamber, an activator for releasing fragrance from the chamber, a spray head and a tube from the activator to a spray head. A shaped body surrounds the fragrance dispenser. The shaped body is designed to accommodate the components of the fragrance dispenser. The spray head can be positioned at any location on the exterior of the shaped body.

According to another aspect of the invention, the shaped body is formed in a shape to function as a decorative novelty item. In particular, the shaped body may be in the form of an animal, such as a skunk or a turtle. Any shapes can be used such that the fragrance dispenser may coordinate with the decor of the room in which it is used. Furthermore, the spray head may be positioned on the spray body to enhance the novelty aspect of the dispenser. According to an aspect of the invention, the body is shaped in the form of a skunk, with the dispenser placed at the tail.

According to another aspect of the invention, the body includes moveable parts for operating the activator. According to another aspect of the invention, the fragrance chamber may be refillable or replaceable. Furthermore, the fragrance chamber may aerosol or pump activated.

### BRIEF DESCRIPTION OF THE DRAWING

FIG. 1 is a cross sectional view of an embodiment of a fragrance dispenser according to an embodiment of the present invention.

### DETAILED DESCRIPTION

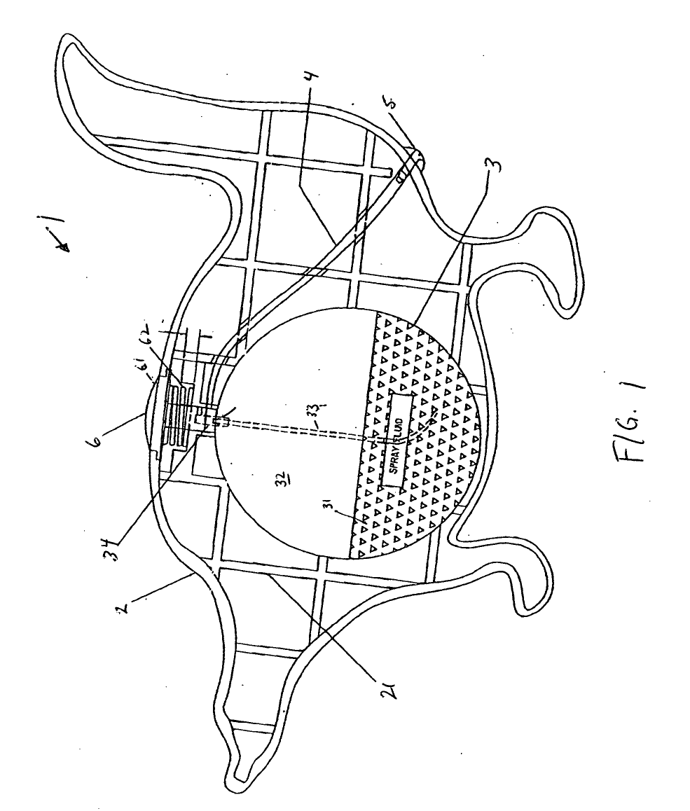

The present invention relates to spray-type fragrance dispensers which have unique shapes. FIG. 1 is a cross sectional view of an embodiment of a fragrance dispenser 1 of the present invention in the form of a an animal, such as a skunk. The body 2 of the fragrance dispenser may be formed of a plastic material in any desired shape. The body 2 may include braces or ribbing 21 to provide structural support for the components of the fragrance dispenser. Furthermore, the body 2 is shaped to accommodate the components of the fragrance dispenser.

As with any fragrance dispenser, the present invention includes a fragrance chamber 3. The fragrance chamber 3 is illustrated has having a circular shape in FIG. 1, but may be of any shape to accommodate the fragrance and to fit within the desired shape of the body. The fragrance chamber 3 may be an integral part of the body, or may be a separate piece placed within the body. Furthermore, the fragrance chamber 3 may be refillable or replaceable. According to an embodiment of the present invention, the fragrance chamber 3 is pressurized. Pressurization may be accomplished by using a aerosol or by using a pumping mechanism (not shown) for adding air to the fragrance chamber 3. As illustrated in FIG. 1, the fragrance chamber, according to an embodiment of the invention, includes a fragrance 31 in liquid form and a pressurized gas 32. A dispensing tube 33 is positioned within the fragrance chamber 3 so that one end is within the fragrance 31. The second end of the dispensing tube 33 is connected to a release valve 34. The release valve 34 may be of any known type. The release valve 34 terminates the end of the dispensing tube 33 so that the fragrance 31 cannot pass. When activated, the release valve 34 opens the end of the dispensing tube 33. Since the contents of the fragrance chamber 3 are under pressure, opening the release valve 34 causes the liquid fragrance 31 to pass through the dispensing tube 33 and release valve 34.

A spray tube 4 is positioned within the body 2 and outside of the fragrance chamber 3. One end of the spray tube is connected to the release valve 34 of the fragrance chamber 3. When the release valve 34 is activated, fragrance passes through the release valve 34 and into the spray tube 4. A second end of the spray tube is connected to a spray head 5. The spray head 5 is positioned at an exterior surface of the body 2. As the liquid fragrance moves through the spray tube, it exits the fragrance dispenser 1 through the spray head 5. The spray head 5 is formed in a known manner to form droplets or spray of the liquid fragrance which moves through it.

An activator 6 is positioned on the body 2 to allow operation of the release valve 34. As illustrated in FIG. 1, the activator 6 may include a plunger 61 and a compression spring 62. Moving the plunger 61 towards the fragrance chamber 3 opens the release valve 34. The spring 62 returns the plunger 61 in the opposite direction to close the release valve.

FIG. 1 illustrates a first embodiment of the present invention. Other variations and modifications are possible. For example, the spray head 5 may be positioned anywhere on the body. The spray tube 4 would be routed appropriately for the position of the spray head 5. As illustrated in FIG. 1, the spray head may be positioned at the base of the tail of skunk shaped body. Alternatively, it could be positioned at the blow hole for a whale shaped body 2, or at the mouth of any animal shape. The invention also not limited to animal shapes, but may be a flower or other plant, a rock or other inanimate object, or any other desired shape. FIG. 1 illustrates a the activator 6 as a plunger 61 located on the back of the animal. Any structure which can operate the release valve 34 on the fragrance chamber 3 may be used as the activator 6. For example, a part of the body 2, such as the head or tail, may be hinged to allow movement and operation of the release valve 34.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A fragrance dispenser comprising:
a fragrance chamber holding a fragrance;
a release valve controlling release of the fragrance from the fragrance chamber;
a spray head; and
a spray tube connecting the release valve to the spray head.

2. The fragrance dispenser of claim 1 further comprising a shaped body, wherein the fragrance chamber is positioned within the shaped body and the spray head is located on an exterior surface of the shaped body.

3. The fragrance dispenser of claim 2, wherein the shaped body is in the shape of an animal.

4. The fragrance dispenser of claim 1 further comprising an activator for operating the release valve.

5. The fragrance dispenser of claim 2 further comprising an activator for operating the release valve.

6. The fragrance dispenser of claim 5, wherein the activator is a portion of the shaped body.

7. The fragrance dispenser of claim 1 wherein the fragrance chamber includes:
a liquid fragrance;
a pressurized gas; and
a fragrance tube having an inlet positioned in the liquid fragrance and a outlet at the release valve.

8. The fragrance dispenser of claim 7, further comprising means for inserting a pressurized gas into to fragrance chamber.

9. The fragrance dispenser of claim 7, further comprising means for inserting a liquid fragrance into the fragrance chamber.

10. The fragrance dispenser of claim 1, wherein the fragrance chamber is replaceable.
